(19) United States
(12) Patent Application Publication
(10) Pub. No.: US 2020/0076304 A1
(43) Pub. Date: Mar. 5, 2020

(54) POWER SUPPLY CIRCUIT AND ELECTRIC VEHICLE

(71) Applicant: SONY CORPORATION, TOKYO (JP)

(72) Inventor: YOSHIKI OYAMA, KANAGAWA (JP)

(21) Appl. No.: 16/466,223

(22) PCT Filed: Nov. 14, 2017
(86) PCT No.: PCT/JP2017/040874

§ 371 Date: Jun. 3, 2019

(30) Foreign Application Priority Data
Dec. 21, 2016 (JP) 2016-247699

(51) Int. Cl. H02M 3/158; B60L 50/50

(52) U.S. Cl. CPC H02M 3/1582; B60L 2210/10; B60L 50/50

(57) ABSTRACT

A power supply circuit includes: a first switching element pair having a high-side first switching element and a low-side second switching element; a second switching element pair having a high-side third switching element and a low-side fourth switching element; and a control section complementarily driving the respective switching elements in the first and second switching element pairs, in which the control section sets a buck-boost ratio in a third operation mode in such a way that a buck-boost ratio in a first operation mode and a buck-boost ratio in a second operation mode continuously change, and sets a switching duty of the first switching element pair and a switching duty of the second switching element pair on the basis of the buck-boost ratio in the third operation mode.

### TECHNICAL FIELD

The present disclosure relates to a power supply circuit and an electric vehicle.

### BACKGROUND ART

Heretofore, a converter which can perform a buck-boost operation has been proposed. For example, PTL 1 describes a converter which operates as a step-down converter in a case where an input voltage is higher than an output voltage, operates as a step-up converter in a case where the input voltage is lower than the output voltage, and operates as a buck-boost converter in a case where the input voltage and the output voltage are relatively close in level to each other.

### CITATION LIST

### Patent Literature

### [PTL 1]

Japanese Patent Laid-Open No. 2012-34516

### SUMMARY

### Technical Problem

In such a field, it is desired to switch the operation over to another one without fluctuating the output from the power supply circuit as much as possible.

Therefore, it is one of objects of the present disclosure to provide a power supply circuit and an electric vehicle in each of which an operation can be switched over to another one without fluctuating an output from the power supply circuit as much as possible.

### Solution to Problem

The present disclosure, for example, is a power supply circuit including: a first switching element pair having a high-side first switching element and a low-side second switching element; a second switching element pair having a high-side third switching element and a low-side fourth switching element; and a control section complementarily driving the respective switching elements in the first and second switching element pairs, in which the control section sets a buck-boost ratio in a third operation mode in such a way that a buck-boost ratio in a first operation mode and a buck-boost ratio in a second operation mode continuously change, and sets a switching duty of the first switching element pair and a switching duty of the second switching element pair on a basis of the buck-boost ratio in the third operation mode.

In addition, the present disclosure may be an electric vehicle including: a conversion device receiving supply of a power from a power supply system including the power supply circuit above described, and converting the power into a driving force of a vehicle; and a controller executing information processing related to vehicle control on a basis of information associated with a power storage device.

### Advantageous Effect of Invention

According to at least one embodiment of the present disclosure, the operation can be switched over to another one without fluctuating the output from the power supply circuit as much as possible. It should be noted that the effect described here is not necessarily limited, and any of effects described in the present disclosure may be offered. In addition, the contents of the present disclosure are not interpreted in a limiting sense by the exemplified effect.

### BRIEF DESCRIPTION OF DRAWINGS

FIG. 1 is a circuit diagram depicting an example of a configuration of a power supply circuit according to an embodiment.

FIG. 2A and FIG. 2B are respectively graphs for explaining an example of an operation of the power supply circuit according to the embodiment.

FIG. 3A and FIG. 3B are respectively graphs for explaining a concrete example of an operation of the power supply circuit according to the embodiment.

FIG. 4 is a block diagram for explaining an application example.

FIG. 5 is a block diagram for explaining another application example.

### DESCRIPTION OF EMBODIMENT

Hereinafter, an embodiment and the like of the present disclosure will be described with reference to drawings. It should be noted that the description is given in accordance with the following order.

### <1. Embodiment>

### <2. Modified Examples>

### <3. Application Examples>

An embodiment and the like which will be described below are preferred concrete examples of the present disclosure, and the contents of the present disclosure are by no means limited to the embodiment and the like.

### Embodiment

### [1. Example of Configuration of Power Supply Circuit]

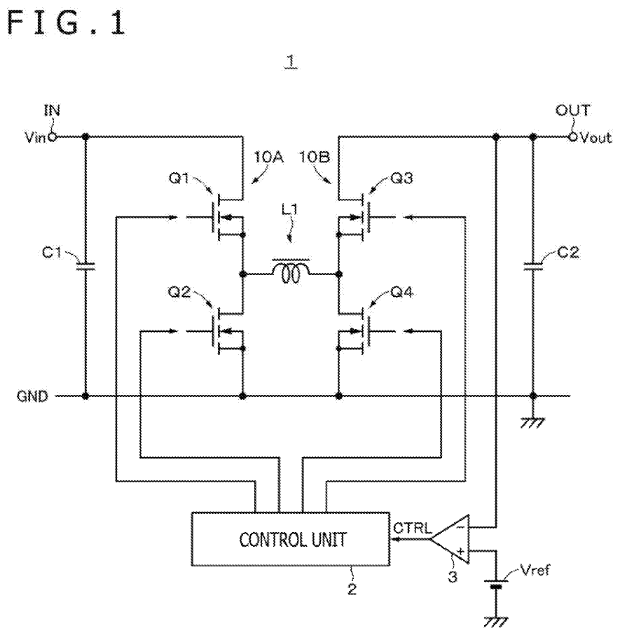

FIG. 1 is a circuit diagram depicting an example of a configuration of a power supply circuit (power supply circuit 1) according to an embodiment. The power supply circuit 1, for example, is a converter which can perform buck-boost operation of an input voltage. The power supply circuit 1 is schematically configured by coupling a half-bridge circuit 10A in which an N-channel MOSFET (Metal Oxide Semiconductor Field Effect Transistor) Q1 as an example of a switching element and a MOSFET Q2 are connected in series with each other, and a half-bridge circuit 10B in which a MOSFET Q3 and a MOSFET Q4 are connected in series with each other. A first switching element pair is configured by the MOSFETs Q1 and Q2, and a second switching element pair is configured by the MOSFETs Q3 and Q4.

An example of a configuration of the power supply circuit 1 is described in detail. Each of an input terminal IN and a ground GND is connected to the half-bridge circuit 10A. Specifically, the input terminal IN is connected to the MOSFET Q1 as the high-side switching element, and the ground GND is connected to the MOSFET Q2 as the low-side switching element. It should be noted that the high-side switching element means a switching element connected to a high-potential side, and the low-side switching element means a switching element connected to a low-potential side.

The input terminal IN is connected to a power supply not depicted, and an input voltage Vin is supplied from the power supply to the power supply circuit 1. The input voltage Vin, for example, is approximately 100 to 400 V. A capacitor C1 for stabilization is connected between the input terminal IN and the ground GND.

Each of an output terminal OUT and the ground GND is connected to the half-bridge circuit 10B. Specifically, the output terminal OUT is connected to the MOSFET Q3 as the high-side switching element, and the ground GND is connected to the MOSFET Q4 as the low-side switching element. A capacitor C2 and a load not depicted are connected to an output side of the half-bridge circuit 10B.

A connection midpoint between the MOSFET Q1 and the MOSFET Q2, and a connection midpoint between the MOSFET Q3 and the MOSFET Q4 are connected to each other via an inductor L1.

A control unit 2 as an example of a control section complementarily drives the MOSFET Q1 and the MOSFET Q2 configuring a first switching element pair. In addition, the control unit 2 complementarily drives the MOSFET Q3 and the MOSFET Q4 configuring a second switching element pair. The wording complementarily drives means the driving which is performed in such a way that when one MOSFET is in an ON state, the other MOSFET is in an OFF state. It should be noted that the control unit 2 calculates the periods of time for which the respective MOSFETs are turned ON/OFF, or the like by, for example, a digital arithmetic operation.

An error amplifier 3, for example, compares a voltage (output voltage) Vout outputted from the output terminal OUT with a reference voltage Vref, and outputs a comparison result as a feedback signal CTRL to the control unit 2. The control unit 2 performs the control in such a way that the switching of the respective MOSFETs is adjusted on the basis of the feedback signal CTRL, and the output from the power supply circuit 1 becomes a constant voltage.

It should be noted that as depicted in FIG. 1, the power supply circuit 1 according to the embodiment has a configuration which is bilaterally symmetric, and is a bi-directional circuit (converter) which operates even in the case where the input side and the output side are reversed. For example, the batteries are respectively connected to the input side and the output side of the power supply circuit 1, and the charging and the discharging can be exchanged between the batteries via the power supply circuit 1.

### [Example of Operation of Power Supply Circuit]

Next, a description will be given with respect to an example of an operation of the power supply circuit 1. In the case where an input voltage Vin applied to the input terminal IN is higher than an output voltage Vout outputted from the output terminal OUT, the power supply circuit 1 operates as a step-down converter. It should be noted that a mode in which the power supply circuit 1 operates as the step-down converter is suitably referred to as a step-down mode (first operation mode). In the step-down mode, the control unit 2 performs the control in which the MOSTEFTs Q1 and Q2 are alternatively turned ON/OFF, the MOSFET Q3 is always held in the ON state, and the MOSFET Q4 is always held in the OFF state.

Contrary to this, in the case where the input voltage Vin applied to the input terminal IN is lower than the output voltage Vout outputted from the output terminal OUT, the power supply circuit 1 operates as a step-up converter. It should be noted that a mode in which the power supply circuit 1 operates as the step-up converter is suitably referred to as a step-up mode (second operation mode). In the step-up mode, the control unit 2 performs the control in which the MOSTEFTs Q3 and Q4 are alternatively turned ON/OFF, the MOSFET Q1 is always held in the ON state, and the MOSFET Q2 is always held in the OFF state.

Incidentally, in the case where the input voltage Vin and the output voltage Vout are the voltages very close in level to each other, an ON duty of the MOSFET Q2 (a rate of a period of time for which a MOSFET is turned ON in a predetermined switching cycle) or an ON duty of the MOSFET Q4 becomes a value close to 0. Actually, each of these ON duties has a lower limit, and there is the possibility that when the ON duty is below a certain level, the switching is not properly performed. Therefore, in the case where the input voltage Vin and the output voltage Vout are the voltages close in level to each other, the buck-boost operation is performed. It should be noted that the mode in which the power supply circuit 1 performs the buck-boost operation is suitably referred to as a buck-boost mode (third operation mode). In the buck-boost mode, the control unit 2 performs the control in such a way that while the MOSFETs Q1 and Q2 are alternately turned ON/OFF, the MOSFETs Q3 and Q4 are alternately turned ON/OFF.

In the first to third operation modes, when the ON duty of the MOSFET Q2 is Din, and the ON duty of the MOSFET Q4 is Dout, the buck-boost ratio between the input voltage and the output voltage can be prescribed by following Equation (1):

(1−Din)/(1−Dout) (1)

The control unit 2 performs the adjustment of the duties of the MOSFETs and the switching of the operation modes on the basis of a feedback signal CTRL inputted from the error amplifier 3.

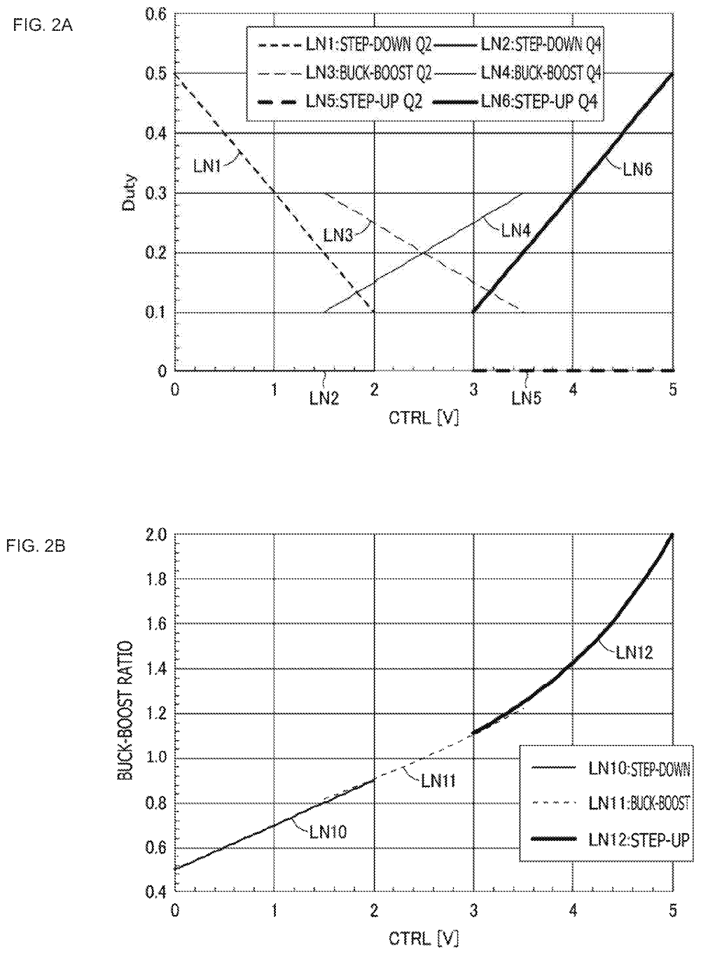

FIG. 2A is a graph depicting an example of a relationship between the voltage of the feedback signal CTRL, and the ON duties of the MOSFETs Q2 and Q4. In FIG. 2A, an axis of abscissa represents a voltage [V] of the feedback signal CTRL, and an axis of ordinate represents a value of the ON duty. In addition, a line LN1 in FIG. 2A indicates a change in ON duty of the MOSFET Q2 in the step-down mode, and a line LN2 indicates a change in ON duty of the MOSFET Q4 in the step-down mode. A line LN3 indicates a change in ON duty of the MOSFET Q2 in the buck-boost mode, and a line LN4 indicates a change in ON duty of the MOSFET Q4 in the buck-boost mode. A line LN5 indicates a change in ON duty of the MOSFET Q2 in the step-up mode, and a line LN6 indicates a change in ON duty of the MOSFET Q4 in the step-up mode.

FIG. 2B is a graph depicting an example of a relationship between the voltage of the feedback signal CTRL and a buck-boost ratio obtained from Equation (1) described above. In FIG. 2B, an axis of abscissa represents the voltage [V] of the feedback signal CTRL, and an axis of ordinate represents the buck-boost ratio. In FIG. 2B, a line LN10 indicates a change in buck-boost ratio in the step-down mode, a line LN11 indicates a change in buck-boost ratio in the buck-boost mode, and a line LN12 indicates a change in buck-boost ratio in the step-up mode.

In FIG. 2A and FIG. 2B, a range of the feedback signal CTRL, for example, is set to 0 to 5 V, and the buck-boost ratio is set so as to change up to 0.5 to 2.0 in this range. With regard to the duty, in the range from 0 to less than 0.1, the driving of the MOSFET goes wrong, and thus there is the case where the MOSFET is not perfectly turned ON, or the case where the MOSFET is not turned ON at all. Therefore, the operation of the MOSFET in this range is prohibited. However, in the case where the duty is 0, in other words, in the case where no switching operation is performed, and thus the MOSFET continuously keeps turn OFF state (each of the MOSFETs Q1 and Q3 is continuously kept turn ON state), since there is no problem in operation, the operation is permitted.

As depicted in FIG. 2A, in the case where the voltage of the feedback signal CTRL falls in the range from 0 to 2 V, the power supply circuit 1 operates in the step-down mode. In the step-down mode, the ON duty of the MOSFET Q4 is set so as to maintain 0. The ON duty of the MOSFET Q2 is set to 0.5 when the feedback signal CTRL is 0 V, and set to 0.1 when the feedback signal CTRL is 2 V. In addition, the ON duty of the MOSFET Q4 changes in a linear relationship as indicated by the line LN1.

In the case where the feedback signal CTRL falls in the range from 3 to 5 V, the power supply circuit 1 operates in the step-up mode. In the step-up mode, the ON duty of the MOSFET Q2 is set so as to maintain 0. The ON duty of the MOSFET Q4 is set to 0.1 when the feedback signal CTRL is 3 V, and set to 0.5 when the feedback signal CTRL is 5 V. In addition, the ON duty of the MOSFET Q4 changes in a linear relationship as indicated by the line LN6.

In the case where the feedback signal CTRL falls in the range from 1.5 to 3.5 V, the power supply circuit 1 operates in the buck-boost mode. It should be noted that with respect to the case where the feedback signal CTRL falls between the range from 1.5 to 2 V (an example of a first range), the power supply circuit 1 can operate in any operation mode selected from the step-down mode and the buck-boost mode. In addition, with respect to the case where the feedback signal CTRL falls between the range from 3 to 3.5 V (an example of a second range), the power supply circuit 1 can operate in any operation mode selected from the step-up mode and the buck-boost mode.

In FIG. 2B, as described above, the buck-boost ratio in the step-down mode is indicated by the line LN 10, and the buck-boost ratio in the step-up mode is indicated by the line LN 12. For example, the buck-boost ratio in the buck-boost mode is set in such a way that the buck-boost ratio in the step-down mode, and the buck-boost ratio in the step-up mode change continuously, smoothly (change approximately linearly). Then, the control unit 2 sets the switching duties of the MOSFETs Q1 and Q2 (e.g., the ON duty of the MOSFET Q2), and the switching duties of the MOSFETs Q3 and Q4 (e.g., the ON duty of the MOSFET Q4) on the basis of the set buck-boost ratio, and drives the respective MOSFETs.

For example, the control unit 2 causes a change rate of the ON duty of the MOSFET Q2 in the buck-boost mode to be smaller than a change rate of the ON duty of the MOSFET Q2 in the step-down mode. More specifically, the control unit 2 set the change rate of the ON duty of the MOSFET Q2 in the buck-boost mode to ½ (a half) of the change rate of the ON duty of the MOSFET Q2 in the step-down mode. It should be noted that the change rate of the ON duty, for example, is prescribed by inclinations of the lines LN depicted in FIG. 2A.

In addition, the control unit 2 causes the change rate of the ON duty of the MOSFET Q4 in the buck-boost mode to be smaller than the change rate of the ON duty of the MOSFET Q4 in the step-up mode. More specifically, the control unit 2 sets the change rate of the ON duty of the MOSFET Q4 in the buck-boost mode to ½ (a half) of the change rate of the ON duty of the MOSFET Q4 in the step-up mode.

The ON duties of the MOSFETs Q2 and Q4 in the buck-boost mode are set in the manner as described above, and the MOSFETs Q2 and Q4 are driven on the basis of the ON duties of interest, resulting in that as depicted in FIG. 2B, the buck-boost ratios in the operation modes can be continuously changed. As a result, in the case where the feedback signal CTRL is in the range from 1.5 to 2 V, no matter how the step-down mode and the buck-boost mode are switched over to each other within that range, the buck-boost ratio hardly changes. Therefore, the operation modes can be smoothly switched over to each other without causing the fluctuation of the output from the power supply circuit 1. In addition, since an amount of change of the buck-boost ratio to an amount of change of the feedback signal CTRL is hardly changed, the control characteristics of the power supply circuit 1 are also approximately the same. In addition, in the case where the feedback signal CTRL is in the range from 3 to 3.5 V, no matter how the step-up mode and the buck-boost mode are switched over to each other within that range, the buck-boost ratio hardly changes. Therefore, the operation modes can be smoothly switched over to each other without causing the fluctuation of the output from the power supply circuit 1. In addition, since an amount of change of the buck-boost ratio to an amount of change of the feedback signal CTRL is hardly changed, the control characteristics of the power supply circuit 1 are also approximately the same.

It should be noted that in the operation of the power supply circuit 1 described above, a threshold value with which the operation mode is switched over to another one may be given hysteresis. For example, a first threshold value (first value) with which the step-down mode is switched over to the buck-boost mode may be set to a voltage value of 2 V of the feedback signal CTRL, and a second threshold value (second value) with which the buck-boost mode is switched over to the step-down mode may be set to a voltage value of 1.5 V of the feedback signal CTRL. All it takes is that the first threshold value and the second threshold value are different values, respectively. However, the first threshold value and the second threshold value are respectively set to a maximum value and a minimum value in the range (e.g., the range from 1.5 to 2 V) in which the operation can be performed with any operation mode selected from the step-down mode and the buck-boost mode, resulting in that the large hysteresis when the operation mode is switched over to another one can be taken. Therefore, the operation mode can be prevented from being frequently switched over to another one due to the slight fluctuation in the vicinity of the threshold value.

In addition, for example, a threshold value (third value) with which the step-up mode is switched over to the buck-boost mode may be set to a voltage value of 3.5 V of the feedback signal CTRL, and a threshold value (fourth value) with which the buck-boost mode is switched over to the step-up mode may be set to a voltage value of 3 V of the feedback signal CTRL. All it takes is that the third threshold value and the fourth threshold value are different values, respectively. However, the third threshold value and the fourth threshold value are respectively set to a maximum value and a minimum value in the range (e.g., the range from 3 to 3.5 V) in which the operation can be performed with any operation mode selected from the step-down mode and the buck-boost mode, resulting in that the large hysteresis when the operation mode is switched over to another one can be taken. Therefore, the operation mode can be prevented from being frequently switched over to another one due to the slight fluctuation in the vicinity of the threshold value.

### [Concrete Example of Operation of Power Supply Circuit]

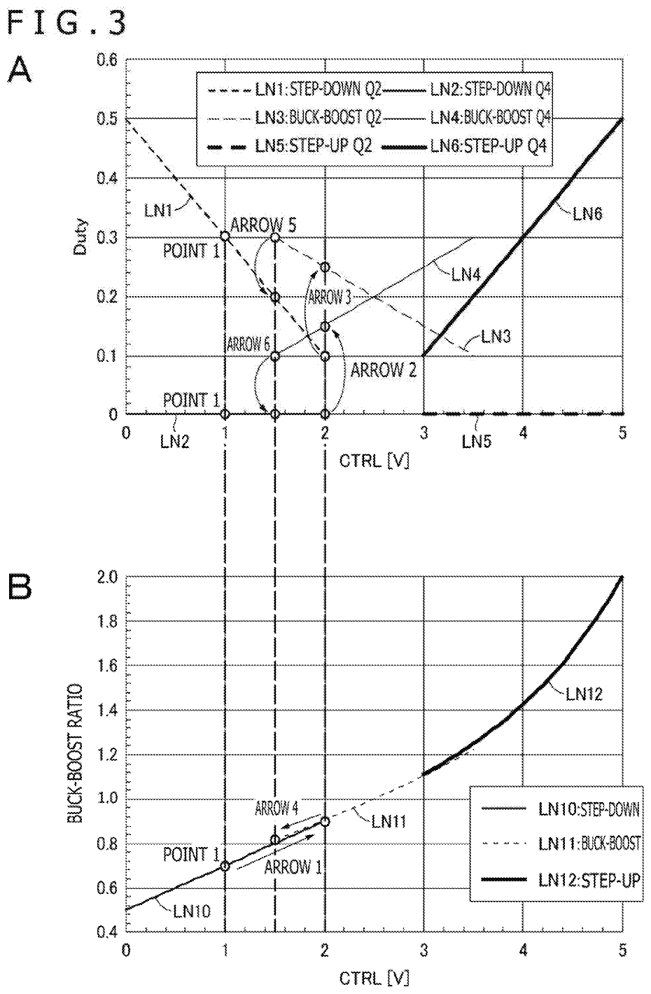

While concrete numerical values are depicted, an example of an operation of the power supply circuit 1 is described with reference to FIG. 3A and FIG. 3B. Descriptions given with respect to FIG. 3A and FIG. 3B (the description given with respect to the axis of abscissa, the axis of ordinate, and the contents represented in the lines LN) are similar to those given with respect to FIG. 2A and FIG. 2B described above. In this example, a description will be given with respect to an example in which the operation mode is switched from the step-down mode over to the buck-boost mode, and an example in which the operation mode is switched from the buck-boost mode over to the step-down mode. Needless to say, numerical values in the following description are merely an example, and the contents of the present disclosure are by no means limited to the numerical values.

For example, since, when the input voltage Vin is 100 V, the output voltage Vout is 70 V, and the power supply circuit 1 is in the steady-state, the buck-boost ratio becomes 0.7, the voltage value of the feedback signal CTRL becomes 1 V (refer to FIG. 3B). Since the voltage value of the feedback signal CTRL is 1 V, the power supply circuit 1 operates in the step-down mode in which the ON duty of the MOSFET Q2 is 0.3 and the ON duty of the MOSFET Q4 is 0 (point 1).

Here, in the case where the input voltage Vin is reduced, the output voltage Vout is reduced. Since the output voltage Vout is connected to a minus side input of the error amplifier 3, when the output is reduced, the voltage value of the feedback signal CTRL as the output voltage of the error amplifier 3 becomes large. As a result, the operation changes so as to increase the buck-boost ratio (an arrow 1 in FIG. 3B), and the ON duty of the MOSFET Q2 continuously decreases so as to follow the line LN1, resulting in that the output voltage Vout is held constant.

Here, when the voltage value of the feedback signal CTRL reaches 2 V, the operation mode is switched from the step-down mode over to the buck-boost mode. In response to the switching of the operation mode, the ON duty of the MOSFET Q2 discontinuously changes from 0.1 on the line LN1 to 0.25 on the line LN3 (an arrow 3 in FIG. 3A). In addition, in response to the switching of the operation mode, the ON duty of the MOSFET Q4 discontinuously changes from 0 on the line LN2 to 0.15 on the line LN4 (an arrow 2 in FIG. 3A).

When in the buck-boost mode, next, the input voltage Vin increases, the voltage value of the feedback signal CTRL decreases. Therefore, the ON duty of the MOSFET Q2 continuously increases, and the ON duty of the MOSFET Q4 continuously decreases, so that the output voltage Vout is held constant (an arrow 4 in FIG. 3B).

Then, when the voltage value of the feedback signal CTRL reaches 1.5 V, the operation mode is switched from the buck-boost mode over to the step-down mode. In response to the switching of the operation mode, the ON duty of the MOSFET Q2 discontinuously changes from 0.3 on the line LN3 to 0.2 on the line LN1 (an arrow 5 in FIG. 3A). In addition, in response to the switching of the operation mode, the ON duty of the MOSFET Q4 discontinuously changes from 0.1 on the line LN4 to 0 on the line LN2 (an arrow 6 in FIG. 3A).

The description has been given with respect to the power supply circuit 1 according to the embodiment of the present disclosure so far. In accordance with the power supply circuit 1 according to the embodiment, for example, the following effects can be obtained.
The switching of the operation modes of the step-down mode and the buck-boost mode, and the step-up mode and the buck-boost mode can be smoothly performed without causing the fluctuation of the output from the power supply circuit, in other words, in such a way that the buck-boost ratio continuously changes.
In addition, the switching of the operation modes is given the sufficient hysteresis, resulting in that it is possible to prevent an unstable operation such that the operation mode is frequency switched over to another one from being performed.
Since the operation modes, for example, are only three modes: the step-down mode; the buck-boost mode; and the step-up mode, a circuit configuration or a program for control can be simplified.

With the technology described in PTL 1, when the point of the switching of the operation mode is decided as the specific voltage ratio between the input voltage and the output voltage, in the case where the input and output voltages are fluctuated in front and behind the voltage ratio, the switching of the operation mode frequency occurs, so that the operation becomes unstable. However, with the power supply circuit 1 according to the embodiment, such a problem can be avoided. In addition, with the technology described in PTL 1, although the buck-boost ratios in front and behind the switching of the operation mode are the same, an amount of change of the buck-boost ratio with respect to the output from the error amplifier largely changes in front and behind the switching. Therefore, it is also possible that the feedback control becomes unstable. However, since with the power supply circuit 1 according to the embodiment, the buck-boost ratio at the time of the switching of the operation mode continuously changes, the problem described above can be avoided.

### 2. Modified Examples

Although the embodiment of the present disclosure has been concretely described so far, the contents of the present disclosure are by no means limited to the embodiment described above, and various kinds of modifications based on the technical idea of the present disclosure can be made.

The numerical values or the like in the embodiment are merely an example, and the contents of the present disclosure are by no means limited to the exemplified numerical value. For example, the value of the feedback signal is by no means limited to the range from 0 to 5 V. Although with respect to the duty as well, in the embodiment, 0.1 is the minimum value, the minimum value may be set to 0.05 or the like depending on the characteristics of the switching element or the drive circuit for the switching element. Although with respect to the range of the buck-boost ratio as well, in the embodiment, the buck-boost ratio is set up to 0.5 to 2.0, with respect to the range of less than 0.5, and the range of more than 2.0, the simple step-down operation or step-up operation has only to be performed. Therefore, the range of the buck-boost ratio needs not to be limited to the range from 0.5 to 2.0.

Although in the embodiment described above, the feedback signal is generated on the basis of the output voltage, the feedback signal may also be generated on the basis of the output current or the like. In addition, although in the embodiment described above, the constant voltage control by which the output voltage is held constant is given as the example, the present disclosure can also be applied to other control such as the constant voltage control by which the output current or the input current is held constant.

In the embodiment described above, the ON duties of the MOSFETs Q2 and Q4 with which the buck-boost ratios in the step-down mode, the buck-boost mode, and the step-up mode continuously change are each prescribed by the linear function. However, if the buck-boost ratios in the step-down mode, the buck-boost mode, and the step-up mode continuously change, then, the ON duties of the MOSFETs Q2 and Q4 may also be each prescribed by a matter other than the linear function. For example, there may also be used a table in which the ON duties, of the MOSFETs Q2 and Q4 corresponding to the feedback signal CTRL, with which the buck-boost ratios in the step-down mode, the buck-boost mode, and the step-up mode continuously change. Then, the control unit 2 may perform the switching of the respective MOSFETs by referring to the table.

In the power supply circuit 1 described above, in order to drive the MOSFET which is always turned ON (the MOSFET Q3 in the step-down mode and the MOSFET Q1 in the step-up mode), a bootstrap circuit for generating a drive signal stepped up to the input voltage Vin or more may be provided.

Another element such as an IGBT (Insulated Gate Bipolar Transistor) may be used as the switching element.

The configuration, the method, the process, the shape, the material, and the numerical values, and the like which are given in the embodiment described above are merely an example, and a configuration, a method, a process, a shape, a material, numerical values, and the like which are different from those in the embodiment may be included if necessary. In addition, the matters described in the embodiment and the modified examples can be combined with each other as long as the technical contradiction is caused.

It should be noted that the present disclosure can also adopt the following configurations.

(1)

A power supply circuit, including:

a first switching element pair having a high-side first switching element and a low-side second switching element;

a second switching element pair having a high-side third switching element and a low-side fourth switching element; and

a control section complementarily driving the respective switching elements in the first and second switching element pairs, in which

the control section sets a buck-boost ratio in a third operation mode in such a way that a buck-boost ratio in a first operation mode and a buck-boost ratio in a second operation mode continuously change, and sets a switching duty of the first switching element pair and a switching duty of the second switching element pair on a basis of the buck-boost ratio in the third operation mode.

(2)

The power supply circuit according to (1), in which the first operation mode is an operation mode in which an input voltage is stepped down, the second operation mode is an operation mode in which the input voltage is stepped up, and the third operation mode is an operation mode in which the input voltage is stepped up and down.

(3)

The power supply circuit according to (2), in which the control section

drives the first switching element and the second switching element in the first operation mode,

drives the third switching element and the fourth switching element in the second operation mode, and

drives the third switching element and the fourth switching element while driving the first switching element and the second switching element in the third operation mode.

(4)

The power supply circuit according to any one of (1) to (3), in which the control section switches the operation mode in response to a feedback signal generated on a basis of an output from the power supply circuit.

(5)

The power supply circuit according to (4), in which

in a case where a value of the feedback signal falls within a first range, the power supply circuit can operate in an operation mode selected from the first operation mode and the third operation mode, and

in a case where the value of the feedback signal falls within a second range, the power supply circuit can operate in an operation mode selected from the second operation mode and the third operation mode.

(6)

The power supply circuit according to (5), in which

setting is performed in such a way that in a case where the value of the feedback signal is a first value within the first range, the operation mode is switched from the first operation mode over to the third operation mode, and setting is performed in such a way that in a case where the value of the feedback signal is a second value different from the first value within the first range, the operation mode is switched from the third operation mode over to the first operation mode, and

setting is performed in such a way that in a case where the value of the feedback signal is a third value within the second range, the operation mode is switched from the second operation mode over to the third operation mode, and setting is performed in such a way that in a case where the value of the feedback signal is a fourth value different from the third value within the second range, the operation mode is switched from the third operation mode over to the second operation mode.

(7)

The power supply circuit according to (6), in which

the first value is a maximum value within the first range, and the second value is a minimum value within the first range, and

the third value is a maximum value within the second range, and the fourth value is a maximum value within the second range.

(8)

The power supply circuit according to any one of (1) to (7), in which

a change rate of an ON duty of the second switching element in the third operation mode is set smaller than a change rate of an ON duty of the second switching element in the first operation mode, and

a change rate of an ON duty of the fourth switching element in the third operation mode is set smaller than a change rate of an ON duty of the fourth switching element in the second operation mode.

(9)

The power supply circuit according to (8), in which

the change rate of the ON duty of the second switching element in the third operation mode is set to ½ of the change rate of the ON duty of the second switching element in the first operation mode, and

the change rate of the ON duty of the fourth switching element in the third operation mode is set to ½ of the change rate of the ON duty of the fourth switching element in the second operation mode.

(10)

The power supply circuit according to any one of (1) to (9), in which a connection midpoint between the first switching element and the second switching element, and a connection midpoint between the third switching element and the fourth switching element are connected to each other via an inductor.

(11)

The power supply circuit according to any one of (1) to (10), in which each of the first to fourth switching elements includes an N-channel MOSFET.

(12)

The power supply circuit according to any one of (1) to (11), in which the power supply circuit is a bi-directional circuit which operates even in a case where an input side and an output side are reversed.

(13)

An electric vehicle, including:

a conversion device receiving supply of a power from a power supply system including the power supply circuit according to any one of (1) to (12), and converting the power into a driving force for a vehicle; and

a controller executing information processing related to vehicle control on a basis of information associated with a power storage device.

### 3. Application Examples

The technology pertaining to the present disclosure can be applied to various products. For example, the present disclosure can be realized as a power supply apparatus having the power supply circuit according to the embodiment described above, or a battery unit controlled by the power supply circuit. Moreover, such a power supply apparatus may be realized as an apparatus mounted to any kind of moving body of an automobile, an electric car, a hybrid electric car, a motor cycle, a bicycle, a personal mobility, an airplane, a drone, a ship, a robot, a construction machine, an agricultural machine (tractor), and the like. Hereinafter, although concrete application examples will be described, the contents of the present disclosure are by no means limited to the application examples which will be described below.

### “Power Storage System in Vehicle as Application Example”

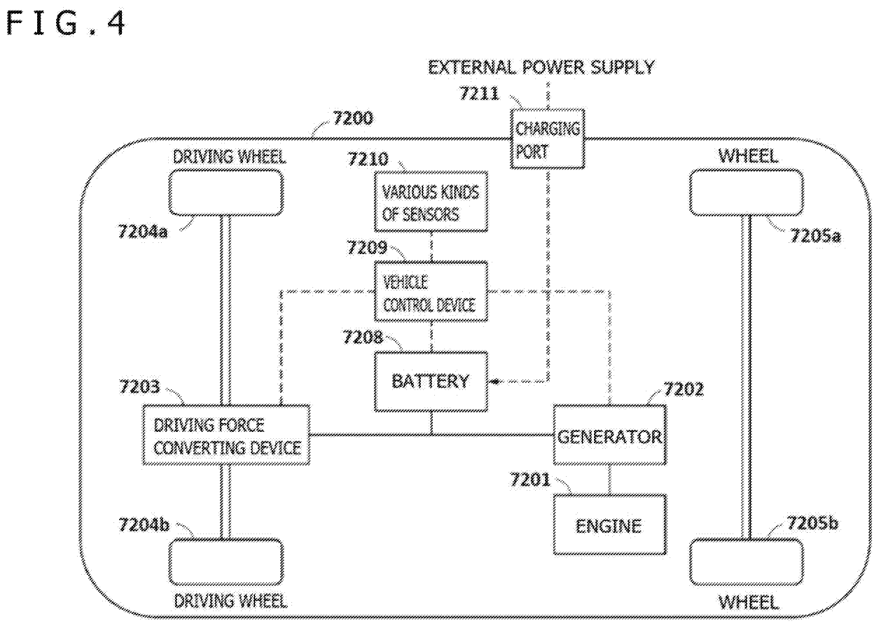

A description will be given with respect to an example in which the present disclosure is applied to a power storage system for a vehicle with reference to FIG. 4. FIG. 4 schematically depicts an example of a configuration of a hybrid vehicle adopting a series hybrid system to which the present disclosure is applied. The series hybrid system is a vehicle which is run by a driving force converting device by using a power generated by a generator moved by an engine, or a power obtained by temporarily storing the generated power in a battery.

This hybrid vehicle 7200 includes an engine 7201, a generator 7202, a power to driving force converting device 7203, a driving wheel 7204a, a driving wheel 7204b, a wheel 7205a, a wheel 7205b, a battery 7208, a vehicle control device 7209, various kinds of sensors 7210, and a charging port 7211. The above-described power supply circuit according to an embodiment of the present disclosure is applied to a control circuit of the battery 7208 and a circuit of the vehicle control device 7209.

The hybrid vehicle 7200 runs with the power to driving force converting device 7203 as a power source. An example of the power to driving force converting device 7203 is a motor. The power to driving force converting device 7203 is activated by the power of the battery 7208. A rotational force of the power to driving force converting device 7203 is transmitted to the driving wheels 7204a and 7204b. Incidentally, the power to driving force converting device 7203 is applicable both as an alternating-current motor and as a direct-current motor by using direct current to alternating current conversion (DC-to-AC conversion) or reverse conversion (AC-to-DC conversion) at a necessary position. The various kinds of sensors 7210 control engine speed via the vehicle control device 7209, and control a degree of opening (degree of throttle opening) of a throttle valve not depicted in the figure. The various kinds of sensors 7210 include a speed sensor, an acceleration sensor, an engine speed sensor, and the like.

A rotational force of the engine 7201 is transmitted to the generator 7202. Power generated by the generator 7202 by the rotational force can be stored in the battery 7208.

When the hybrid vehicle is decelerated by a braking mechanism not depicted in the figure, a resistance force at the time of the deceleration is applied as a rotational force to the power to driving force converting device 7203. Regenerative power generated by the power to driving force converting device 7203 by the rotational force is stored in the battery 7208.

The battery 7208 can also be connected to a power supply external to the hybrid vehicle to be supplied with power from the external power supply with the charging port 7211 as an input port, and store the received power.

Though not depicted, an information processing device may be provided which performs information processing related to vehicle control on the basis of information about the secondary battery. As such an information processing device, there is, for example, an information processing device that makes battery remaining charge amount display on the basis of information about an amount of charge remaining in the battery.

The above description has been made by taking, as an example, a series hybrid vehicle run by a motor using power generated by a generator driven by an engine or power supplied from a battery that stores the power generated by the generator. However, the present disclosure is effectively applicable also to a parallel hybrid vehicle that uses both of outputs of an engine and a motor as driving sources and which appropriately selects and uses three systems, that is, a system in which the vehicle is run by only the engine, a system in which the vehicle is run by only the motor, and a system in which the vehicle is run by the engine and the motor. Further, the present disclosure is effectively applicable also to an electric vehicle run by being driven by only a driving motor without the use of an engine.

The description has been given with respect to the example of the hybrid vehicle 7200 to which the technology pertaining to the present disclosure can be applied so far. The power supply circuit according to the embodiment of the present disclosure, for example, can be applied as a circuit associated with an input and an output to and from the battery 7208.

### “Power Storage System in House as Application Example”

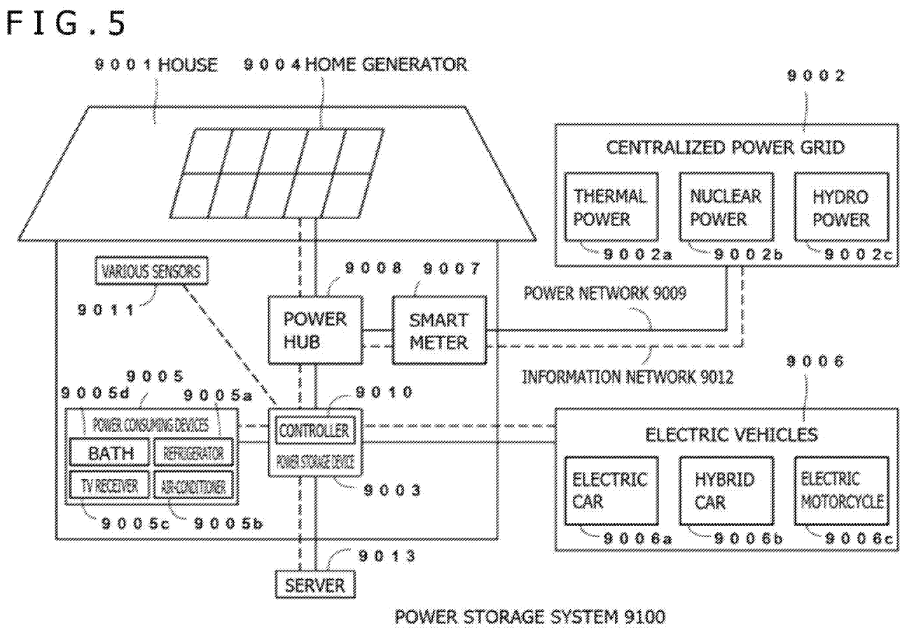

A description will be given with respect to an example in which the present disclosure is applied to a power storage system for a house with reference to FIG. 5. For example, in a power storage system 9100 for a house 9001, the power is supplied from a centralized power grid 9002 such as thermal power generation 9002a, nuclear power generation 9002b, hydro power generation 9002c and the like to a power storage device 9003 via a power network 9009, an information network 9012, a smart meter 9007, a power hub 9008, and the like. Together with this supply of the power, the power is supplied from an independent power supply such as a home generator 9004 to the power storage device 9003. The power supplied to the power storage device 9003 is saved. The power to be used in the house 9001 is fed by using the power storage device 9003. With respect to not only the house 9001, but also a building, the similar power storage system can be used.

The house 9001 is equipped with the generator 9004, power consuming devices 9005, the power storage device 9003, a controller 9010 for controlling these various devices, the smart meter 9007, and sensors 9011 for acquiring various information. These devices are connected by the power network 9009 and the information network 9012. A solar or fuel cell, for example, is used as the generator 9004. Generated electric power is supplied to the power consuming devices 9005 and/or the power storage device 9003. The power consuming devices 9005 are a refrigerator 9005a, an air-conditioner 9005b, a television (TV) receiver 9005c, a bath 9005d, and so on. The power consuming devices 9005 further include electric vehicles 9006. The electric vehicles 9006 are an electric car 9006a, a hybrid car 9006b, and an electric motorcycle 9006c.

A battery unit of the present disclosure described above is used for the power storage device 9003. The power storage device 9003 includes a secondary battery or capacitor. For example, the power storage device 9003 includes a lithium ion battery. The lithium ion battery may be a stationary one or one designed for the electric vehicles 9006. The smart meter 9007 is capable of measuring commercial power consumption and sending the measured consumption to an electric power company. The power network 9009 may include any one or a plurality of direct current (DC), alternating current (AC), and non-contact power supplies.

The various sensors 9011 are, for example, human, illuminance, object detection, power consumption, vibration, contact, temperature, infrared, and other sensors. Information acquired by the various sensors 9011 is sent to the controller 9010. Information from the sensors 9011 makes it possible to find out about meteorological, human, and other conditions, so as to automatically control the power consuming devices 9005 and reduce energy consumption to minimum. Further, the controller 9010 can send information on the house 9001, for example, to an external electric power company via the Internet.

The power hub 9008 handles the division of a power line into branches, DC/AC conversion, and other tasks. Communication schemes used between the controller 9010 and the information network 9012 connected thereto are the one using communication interfaces such as universal asynchronous receiver-transmitter (UART) and the one using sensor networks based on wireless communication standards such as Bluetooth, ZigBee, and wireless fidelity (Wi-Fi). Bluetooth scheme is applied to multimedia communication to permit one-to-many communication. ZigBee uses the physical layer of institute of electrical and electronic engineers (IEEE) 802.15.4. IEEE 802.15.4 is the name of a short-distance wireless network standard that is referred to as personal area network (PAN) or wireless (W) PAN.

The controller 9010 is connected to an external server 9013. The external server 9013 may be managed by any of the house 9001, an electric power company, or a service provider. Information sent and received by the server 9013 is, for example, power consumption information, life pattern information, power rate information, weather information, natural disaster information, and information on electricity trading. These pieces of information may be sent to and received from a power consuming device (e.g., TV receiver) in the home. Alternatively, they may be sent to and received from a device outside of the home (e.g., mobile phone). These pieces of information may be shown on an appliance with a display function such as TV receiver, mobile phone, or personal digital assistant (PDA).

The controller 9010 that controls each of these sections includes, for example, a central processing unit (CPU), a random access memory (RAM), and a read only memory (ROM). In the present example, the controller 9010 is accommodated in the power storage device 9003. The controller 9010 is connected to the power storage device 9003, the home generator 9004, the power consuming devices 9005, the various sensors 9011, and the server 9013 via the information network 9012. The controller 9010 is capable, for example, of regulating commercial power consumption and power output. It should be noted that the controller 9010 may additionally be capable of trading electricity in electricity markets.

As described above, not only electric power from the centralized power grid 9002 including the thermal power 9002a, the nuclear power 9002b, the hydro power 9002c and the like but also that generated by the home generator 9004 (solar and wind power) can be stored in the power storage device 9003. Therefore, it is possible to perform control including, for example, maintaining the externally supplied power constant or discharging the power storage device 9003 as much as possible needed even in the event of a change in power generated by the home generator 9004. For example, it is possible to store electric power obtained from solar power generation and inexpensive midnight power with low night rates in the power storage device 9003, and discharge and use the power stored in the power storage device 9003 in daytime hours with high rates.

It should be noted that although a case has been described in the present example in which the controller 9010 is accommodated in the power storage device 9003, the controller 9010 may be accommodated in the smart meter 9007. Alternatively, the controller 9010 may be a standalone unit. Still alternatively, the power storage system 9100 may be used for a plurality of households in a housing complex. Still alternatively, the power storage system 9100 may be used for a plurality of detached houses.

The description has been given with respect to the example of the power storage system 9100 to which the technology pertaining to the present disclosure can be applied so far. The technology pertaining to the present disclosure, of the configurations described so far, can be suitably applied to the power storage device 9003. Specifically, the power supply circuit according to the embodiment can be applied to the circuit associated with the power storage device 9003.

### REFERENCE SIGNS LIST

1 . . . Power supply circuit
2 . . . Control unit
3 . . . Error amplifier
Q1 to Q4 . . . N-channel MOSFET
L1 . . . Inductor

1. A power supply circuit, comprising:
a first switching element pair having a high-side first switching element and a low-side second switching element;
a second switching element pair having a high-side third switching element and a low-side fourth switching element; and
a control section complementarily driving the respective switching elements in the first and second switching element pairs, wherein
the control section sets a buck-boost ratio in a third operation mode in such a way that a buck-boost ratio in a first operation mode and a buck-boost ratio in a second operation mode continuously change, and sets a switching duty of the first switching element pair and a switching duty of the second switching element pair on a basis of the buck-boost ratio in the third operation mode.

2. The power supply circuit according to claim 1, wherein the first operation mode is an operation mode in which an input voltage is stepped down, the second operation mode is an operation mode in which the input voltage is stepped up, and the third operation mode is an operation mode in which the input voltage is stepped up and down.

3. The power supply circuit according to claim 2, wherein the control section
drives the first switching element and the second switching element in the first operation mode,
drives the third switching element and the fourth switching element in the second operation mode, and
drives the third switching element and the fourth switching element while driving the first switching element and the second switching element in the third operation mode.

4. The power supply circuit according to claim 1, wherein the control section switches the operation mode in response to a feedback signal generated on a basis of an output from the power supply circuit.

5. The power supply circuit according to claim 4, wherein
in a case where a value of the feedback signal falls within a first range, the power supply circuit can operate in an operation mode selected from the first operation mode and the third operation mode, and
in a case where the value of the feedback signal falls within a second range, the power supply circuit can operate in an operation mode selected from the second operation mode and the third operation mode.

6. The power supply circuit according to claim 5, wherein
setting is performed in such a way that in a case where the value of the feedback signal is a first value within the first range, the operation mode is switched from the first operation mode over to the third operation mode, and setting is performed in such a way that in a case where the value of the feedback signal is a second value different from the first value within the first range, the operation mode is switched from the third operation mode over to the first operation mode, and
setting is performed in such a way that in a case where the value of the feedback signal is a third value within the second range, the operation mode is switched from the second operation mode over to the third operation mode, and setting is performed in such a way that in a case where the value of the feedback signal is a fourth value different from the third value within the second range, the operation mode is switched from the third operation mode over to the second operation mode.

7. The power supply circuit according to claim 6, wherein
the first value is a maximum value within the first range, and the second value is a minimum value within the first range, and
the third value is a maximum value within the second range, and the fourth value is a maximum value within the second range.

8. The power supply circuit according to claim 1, wherein
a change rate of an ON duty of the second switching element in the third operation mode is set smaller than a change rate of an ON duty of the second switching element in the first operation mode, and
a change rate of an ON duty of the fourth switching element in the third operation mode is set smaller than a change rate of an ON duty of the fourth switching element in the second operation mode.

9. The power supply circuit according to claim 8, wherein
the change rate of the ON duty of the second switching element in the third operation mode is set to ½ of the change rate of the ON duty of the second switching element in the first operation mode, and
the change rate of the ON duty of the fourth switching element in the third operation mode is set to ½ of the change rate of the ON duty of the fourth switching element in the second operation mode.

10. The power supply circuit according to claim 1, wherein a connection midpoint between the first switching element and the second switching element, and a connection midpoint between the third switching element and the fourth switching element are connected to each other via an inductor.

11. The power supply circuit according to claim 1, wherein each of the first to fourth switching elements includes an N-channel MOSFET.

12. The power supply circuit according to claim 1, wherein the power supply circuit is a bi-directional circuit which operates even in a case where an input side and an output side are reversed.

13. An electric vehicle, comprising:
a conversion device receiving supply of a power from a power supply system including the power supply circuit according to claim 1, and converting the power into a driving force for a vehicle; and
a controller executing information processing related to vehicle control on a basis of information associated with a power storage device.
